(19) United States
(12) Patent Application Publication
(10) Pub. No.: US 2006/0168632 A1
(43) Pub. Date: Jul. 27, 2006

(54) Video reception device, video transmission device, and video transmission system

(76) Inventors: Yoshimasa Honda, Kamakura-shi (JP); Tsutomu Uenoyama, Kawasaki-shi (JP)

Correspondence Address: NATH & ASSOCIATES, 112 South West Street, Alexandria, VA, 22314, US

(21) Appl. No.: 10/515,226

(22) PCT Filed: Feb. 20, 2004
(86) PCT No.: PCT/JP04/01989

§ 371 Date: Nov. 22, 2004

(51) Int. Cl. H04N 7/173

(52) U.S. Cl. 725/95

(57) ABSTRACT

A video transmission system that achieves uninterrupted video transmission, even when there are large bit rate fluctuation due to receiving terminal movement and so forth, in a network such as a wireless network in which transmission bit rate fluctuations occur. In this system, when a video receiving apparatus (receiving terminal) 150 is moving, a video transmitting apparatus (transmitting terminal) 100 lowers the base layer bit rate of layered-coded data to the limit. When the base layer bit rate is lowered in this way, the bit rate of the lowest enhancement layer is raised and effects on the received image quality of other terminals due to lowering of the base layer are suppressed, or the lowest enhancement layer is divided finely and the adjustability to a bit rate under bit rate fluctuations is improved.

### TECHNICAL FIELD

The present invention relates to a video transmission system that transmits video via a network.

### BACKGROUND ART

Video data transmitted by a conventional video transmission system is normally compression-coded into a fixed bit rate or below by means of a method such as H.261 or MPEG (Moving Picture Experts Group) so that it can be transmitted with a fixed transmission bit rate, and once video data has been coded the video quality cannot be changed even if the transmission bit rate changes. Here, a bit rate indicates a transmission bit rate.

However, with the diversification of networks in recent years, transmission path bit rate width fluctuations have become large, and video data has become necessary that enables video transmission at quality commensurate with a plurality of bit rates. In response to this need, layered coding methods have been standardized that have a layered structure and can handle a plurality of bit rates. Among such layered coding methods, recently standardized MPEG-4 FGS (Fine Granularity Scalability) (ISO/IEC 14496-2 Amendment 2:2001), in particular, is a layered coding method with a high degree of freedom regarding bit rate selection. Video data coded by MPEG-4 FGS is composed of a base layer, which is a moving picture stream for which stand-alone decoding is possible, and at least one enhancement layer, which is a moving picture stream for improving base layer decoded moving picture quality. The base layer is video data of low picture quality in a low bit rate, and a high degree of flexibility in achieving high picture quality is possible by adding the enhancement layer corresponding to the band.

In MPEG-4 FGS, the total data size of an enhancement layer to be transmitted can be controlled to allow application to a variety of bit rates, and it is possible to transmit video of quality that is in accordance with the bit rate.

Thus, any video coding method has a role of performing compression coding to enable input video to be transmitted in a predetermined bit rate, and controlling the video data bit rate to an appropriate value. Therefore, if the video data bit rate is high compared with the transmission path bit rate, video data cannot be transmitted in real time, and not only does delay occur in video in a receiving apparatus, but video data is lost in the network and video halts (interruption occurs). On the other hand, if the video data bit rate is lower than the transmission path bit rate, delay does not occur but video quality degrades to an extreme degree. Particularly in cases where real-time capability and high picture quality are required, such as video telephony and live transmissions, it is necessary to match the video data bit rate to the transmission path bit rate.

In conventional technologies for preventing interruption of video due to bit rate fluctuations, a server selects and transmits one of a plurality of video streams of different bit rates generated beforehand, according to a bit rate change request from a receiving terminal (see, for example, page 1 and FIG. 1 of Unexamined Japanese Patent Publication No. HEI 10-336626).

FIG. 1 is a drawing showing an example of the configuration of a conventional video transmission system.

In a server 10, a transfer rate change request from a client 20 receiving a video stream is received by a bit rate switching section 11, and video data of the corresponding bit rate is selected from a different bit rate video data storage section 13 and transmitted to client 20.

At client 20, video data transmitted from server 10 is received by a video data receiving section 21 and output to a data buffer management section 23, and the reception speed is output to a playback data management section 25. Data buffer management section 23 stores video data input from video data receiving section 21 in an internal buffer, manages the storage status, outputs the retention data status to playback data management section 25, and also, in the event of a data read request from a video decoding/display section 27, reads video data from the internal buffer and outputs this data to video decoding/display section 27. Video decoding/display section 27 outputs a data read request to data buffer management section 23, and decodes and displays video data input from data buffer management section 23. Playback data management section 25 performs transfer bit rate change determination using the retention data status input from data buffer management section 23 and reception speed input from video data receiving section 21, and outputs the changed bit rate to a rate change request section 29. The transfer bit rate change determination method used in playback data management section 25 at this time is as follows: if the retention data exceeds an upper threshold value, the average reception speed up to immediately prior to that time is calculated and a bit rate reduction request is decided on; on the other hand, if the retention data is less than a lower threshold value, the average reception speed up to immediately prior to that time is calculated and a bit rate increase request is decided on. Rate change request section 29 transmits a bit rate change request to server 10 using the bit rate input from playback data management section 25.

Thus, with conventional technology, it is possible for video to be received by a receiving terminal (client 20) without interruption by having a server 10 select suitable data from among video data of different bit rates in response to a bit rate change request from the receiving terminal, and transmit that data.

However, with conventional technology, video data bit rate control is performed using an average bit rate, and therefore when the transmission path bit rate fluctuates greatly due to receiving terminal movement, for example, there is a large difference between the average bit rate and the actual bit rate. When the video data bit rate is higher than the transmission bit rate, in particular, video data cannot be transmitted in real time, and not only does delay arise in the video, but also video data is lost in the network and video halts (interruption occurs). A video transmission system is therefore desirable that will make uninterrupted video reception possible even when there are large transmission bit rate fluctuations due to receiving terminal movement and so forth.

### DISCLOSURE OF INVENTION

It is an object of the present invention to provide a video transmission system whereby uninterrupted video transmission can be achieved, even when there are large bit rate fluctuations due to receiving terminal movement and so forth, in a network such as a wireless network in which transmission bit rate fluctuations occur.

According to one aspect of the present invention, a video receiving apparatus that receives layered-coded data includes a transmitting section that transmits specific information of the video receiving apparatus, and a receiving section that is bit rate-controlled based on the transmitted specific information, and receives layered-coded data divided into a plurality of channels.

According to another aspect of the present invention, a video transmitting apparatus includes a receiving section that receives specific information of a video receiving apparatus, a control section that controls the bit rate of layered-coded data divided using the received specific information, and a transmitting section that transmits said bit rate control and divided layered-coded data on separate channels.

According to yet another aspect of the present invention, in a video transmitting system wherein layered-coded data is divided into a plurality and transmitted from a video transmitting apparatus to a video receiving apparatus on separate channels, the video transmitting apparatus has a receiving section that receives specific information of the video receiving apparatus, and a control section that controls the bit rate of divided layered-coded data using received specific information, and the video receiving apparatus has a transmitting section that transmits the specific information.

### BRIEF DESCRIPTION OF THE DRAWINGS

FIG. 1 is a drawing showing an example of the configuration of a conventional video transmission system;

FIG. 2 is a drawing showing the configuration of a video transmission system according to Embodiment 1 of the present invention;

FIG. 3A is a drawing showing an example of the structure of coded data when MPEG-4 FGS coding is used;

FIG. 3B is a drawing showing an example of the result of channel division for the coded data in FIG. 3A;

FIG. 4 is a drawing showing an example of a video list;

FIG. 5 is a drawing for explaining the concept of Embodiment 1;

FIG. 6 is a flowchart showing the operation of a video transmitting apparatus corresponding to Embodiment 1;

FIG. 7 is a flowchart showing the operation of a video receiving apparatus corresponding to Embodiment 1;

FIG. 8A is a sequence diagram showing the main information exchanges during terminal movement in a video transmission system corresponding to Embodiment 1;

FIG. 8B is a sequence diagram showing the main information exchanges in the stationary state in a video transmission system corresponding to Embodiment 1;

FIG. 9 is a configuration diagram showing an example of a video transmission system using MPEG-4 FGS to which Embodiment 1 is applied;

FIG. 10 is a drawing showing the configuration of a video transmission system according to Embodiment 2 of the present invention;

FIG. 11 is a drawing for explaining the concept of Embodiment 2;

FIG. 12 is a flowchart showing the operation of a video transmitting apparatus corresponding to Embodiment 2;

FIG. 13 is a drawing showing the configuration of a video transmission system according to Embodiment 3 of the present invention;

FIG. 14 is a drawing for explaining the concept of Embodiment 3;

FIG. 15 is a flowchart showing the operation of a video transmitting apparatus corresponding to Embodiment 3;

FIG. 16A is a drawing showing an example of the structure of coded data when MPEG-4 FGS coding is used;

FIG. 16B is a drawing showing an example of the result of channel division for the coded data in FIG. 16A in stationary mode;

FIG. 16C is a drawing showing an example of the result of channel division for the coded data in FIG. 16A in mobile mode;

FIG. 17 is a drawing showing the configuration of a video transmission system according to Embodiment 4 of the present invention;

FIG. 18 is a drawing for explaining the concept of Embodiment 4;

FIG. 19A is a drawing showing an example of reception layer information;

FIG. 19B is a drawing showing another example of reception layer information;

FIG. 20 is a flowchart showing the operation of a video transmitting apparatus corresponding to Embodiment 4; and

FIG. 21 is a flowchart showing the operation of a video receiving apparatus corresponding to Embodiment 4.

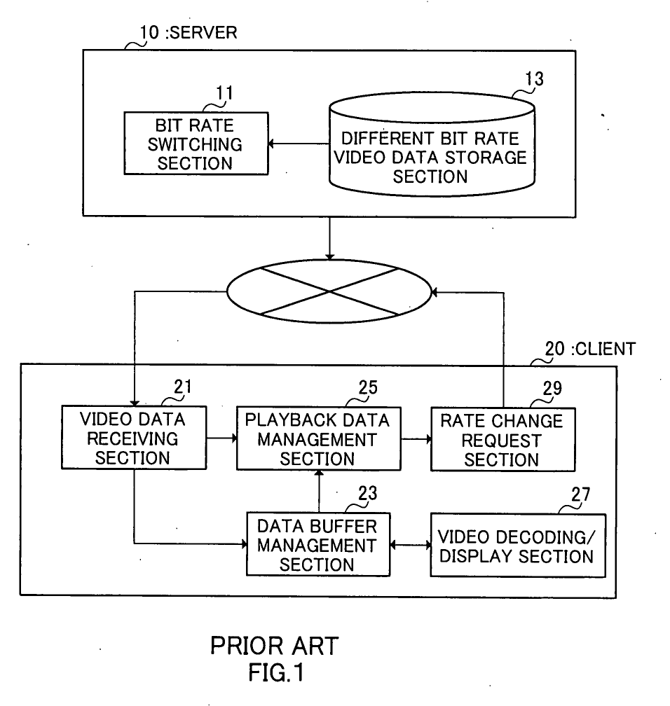

### BEST MODE FOR CARRYING OUT THE INVENTION

The gist of the present invention is that, in a system that transmits a layered-coded video stream to a plurality of terminals, when layered-coded data is divided into a plurality of layers and transmitted on separate channels, layer-specific bit rates are controlled dynamically using information from a receiving terminal (such as handover and user requests, for example).

With reference now to the accompanying drawings, embodiments of the present invention will be explained in detail below.

### Embodiment 1

In this embodiment, a video transmission system that transmits a layered-coded video stream in an environment with large bit rate fluctuations, including wireless network, is described whereby uninterrupted video reception is made possible by lowering the base layer bit rate to the limit when large bit rate fluctuations are expected due to terminal movement and so forth.

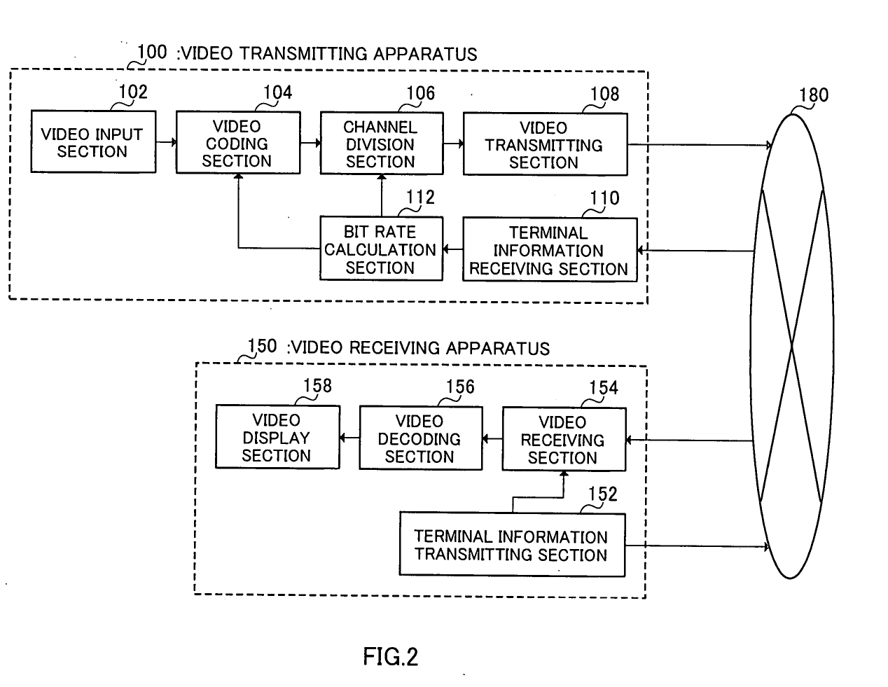

FIG. 2 is a drawing showing the configuration of a video transmission system according to Embodiment 1 of the present invention.

This video transmission system has a video transmitting apparatus (hereinafter also referred to as “transmitting terminal”) 100 that transmits video, a video receiving apparatus (hereinafter also referred to as “receiving terminal”) 150 that receives video, and a network 180 that relays video transmitted from video transmitting apparatus 100 to video receiving apparatus 150. That is to say, video transmitted from video transmitting apparatus 100 is transmitted to video receiving apparatus 150 via network 180.

Video transmitting apparatus 100 has a video input section 102, video coding section 104, channel division section 106, video transmitting section 108, terminal information receiving section 110, and bit rate calculation section 112.

Video input section 102 outputs images making up video provided from outside or generated by the relevant apparatus 100 to video coding section 104 on a frame-by-frame basis.

Video coding section 104 performs layered coding, with an image output from video input section 102 as an input image, and outputs the obtained coded data to channel division section 106.

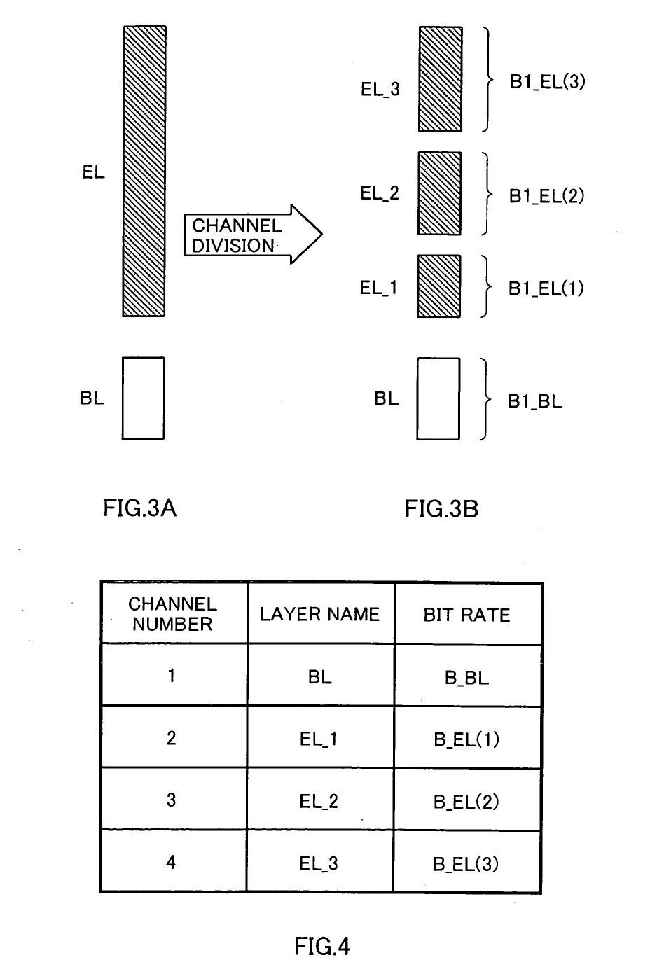

For example, when MPEG-4 FGS coding is used, video coding section 104 generates coded data composed of a base layer (BL), and an enhancement layer (EL) that improves the image quality, for an input image (see FIG. 3A, for example). At this time, in this embodiment, the base layer bit rate is supplied from bit rate calculation section 112.

In this case, image quality can be improved by adding the enhancement layer to the base layer. For the enhancement layer, data division is possible from a lower layer, and the degree of image quality improvement can be controlled according to the amount of data of the enhancement layer added to the base layer.

Channel division section 106 divides coded data output from video coding section 104 into a plurality, and outputs the divided data to video transmitting section 108 together with a video list. At this time, in this embodiment, the enhancement layer division bit rates are given by bit rate calculation section 112. An example of the result of channel division is shown in FIG. 3B. Details of the processing will be given later herein.

An example of a video list is shown in FIG. 4. The video list shows channel numbers, layer names, and the necessary bit rate to receive each layer. The video list is not limited to that shown in FIG. 4, and may be of any kind as long as it shows the bit rate for each channel.

Video transmitting section 108 transmits the divided data and video list output from channel division section 106 to network 180 on separate channels. Specifically, for example, coded data (base layer and enhancement layers) divided and assigned to separate channels are multicast-transmitted to network 180 on separate channels, and a video list showing the bit rate and channel number of each layer is also multicast-transmitted. When multicast transmission is performed, a channel number is indicated by a multicast address, for example. Here, multicast transmission is a method whereby, with regard to a channel on which data is transmitted from one transmitting terminal, data is transmitted only to a terminal for which data reception is selected. As there is no duplication in data transmitted within the same transmission path even when a plurality of receiving terminals perform data reception at the same time, multicast transmission achieves better transmission throughput.

The video stream transmission method is not, of course, limited to multicast transmission but can be applied by unicast or broadcast transmission.

Terminal information receiving section 110 receives terminal information transmitted from a receiving terminal (video receiving apparatus 150), and outputs this information to bit rate calculation section 112. Here, terminal information is information indicating that a receiving terminal is moving or starting to move (terminal movement information).

Using the terminal information output from terminal information receiving section 110, bit rate calculation section 112 calculates the base layer bit rate and enhancement layer division bit rates, and outputs the former (base layer bit rate) to video coding section 104 and the latter (enhancement layer division bit rates) to channel division section 106.

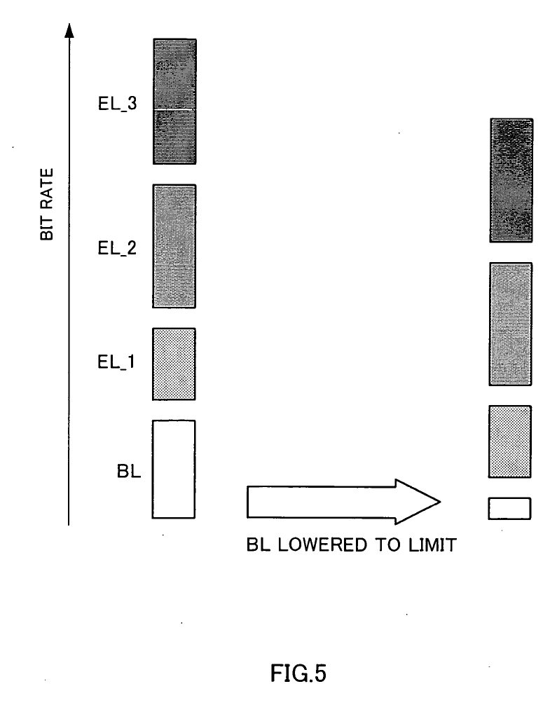

At this time, in this embodiment, when terminal movement information is input, bit rate calculation section 112 lowers the base layer bit rate (bit rate) to the limit and sets an ultra-low bit rate (see FIG. 5). As a result, uninterrupted video reception is possible. At this time, picture quality improvement is provided by the additional enhancement layers. Details of the processing will be given later herein.

Video receiving apparatus 150, meanwhile, has a terminal information transmitting section 152, video receiving section 154, video decoding section 156, and video display section 158.

When it is determined that a terminal is moving or starting to move, terminal information transmitting section 152 transmits terminal movement information to video transmitting apparatus 100 and also outputs this information to video receiving section 154.

Video receiving section 154 receives a video list transmitted from video transmitting apparatus 100, selects a plurality of receivable video data within the video list and receives these data, and outputs the received data to video decoding section 156.

Specifically, video receiving section 154 receives a video list transmitted from video transmitting apparatus 100, compares the bit rates shown in the video list with the current reception bit rates, and determines a plurality of receivable channel numbers in bottom-up channel number order. In this embodiment, when terminal movement information is input from terminal information transmitting section 152, at least the base layer channel is received. Then video receiving section 154 receives the video data of the determined channel numbers, outputs the received video data to video decoding section 156, and also measures current reception bit rates from the amount of received video data.

Video decoding section 156 decodes video data (coded data) output from video receiving section 154, and outputs the video obtained by decoding to video display section 158.

Video display section 158 displays the video output from video decoding section 156 on a screen. This video display section 158 comprises a display device.

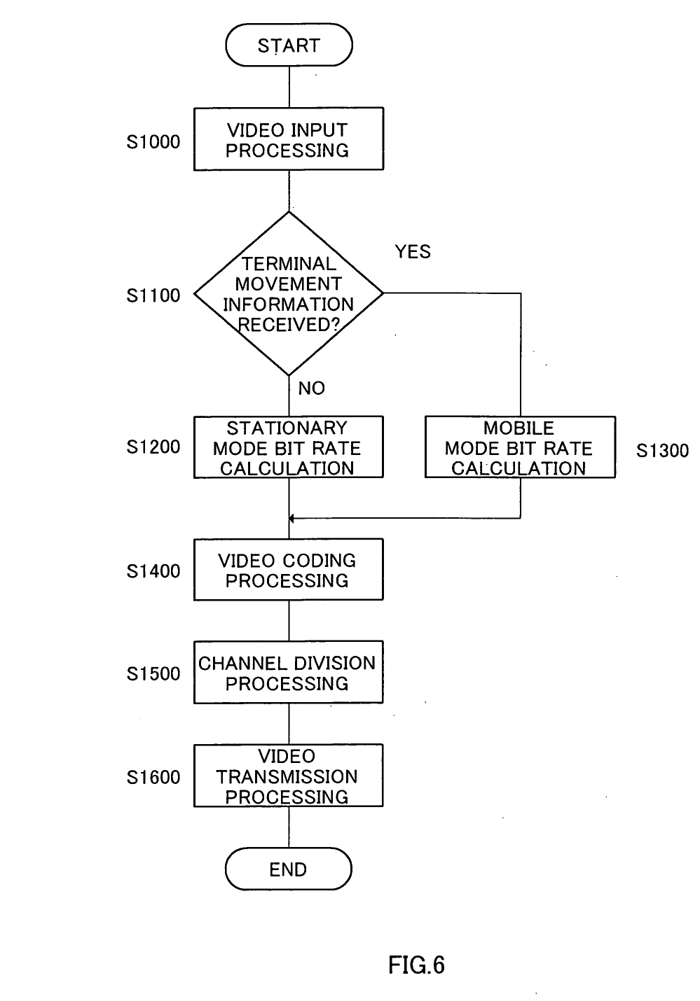

The operation of video transmitting apparatus 100 that has the above configuration will now be described using the flowchart shown in FIG. 6. The flowchart shown in FIG. 6 is stored as a control program in a storage device (such as ROM or flash memory, for example) of video transmitting apparatus 100 not shown in the figure, and executed by a CPU (also not shown).

First, in step S1000, video input section 102 outputs images making up video to video coding section 104 on a frame-by-frame basis.

Then, in step S1100, it is determined whether or not terminal information receiving section 110 has received terminal movement information from the receiving terminal (video receiving apparatus 150). If the result of this determination is that terminal movement information has not been received (S1100: NO), the processing flow proceeds to step S1200, and if the result of this determination is that terminal movement information has been received (S1100: YES), the processing flow proceeds to step S1300.

In step S1200, bit rate calculation section 112 performs stationary mode bit rate calculation processing. Specifically, since this is a case in which terminal movement information from the receiving terminal has not been received, using previously set base layer bit rate B1_BL and enhancement layer division bit rates B1_EL(1) through B1_EL(i) (where i is a preset number of divided layers), the base layer bit rate is output to video coding section 104 and the enhancement layer division bit rates are output to channel division section 106. The processing flow then proceeds to step S1400.

In step S1300, on the other hand, bit rate calculation section 112 performs mobile mode bit rate calculation processing. Specifically, since this is a case in which terminal movement information from the receiving terminal is received, base layer bit rate B_BL and enhancement layer division bit rates B_EL(1) through B_EL(i) (where i is a preset number of divided layers) are calculated, the base layer bit rate is output to video coding section 104, and the enhancement layer division bit rates are output to channel division section 106. The processing flow then proceeds to step S1400.

Here, base layer bit rate B_BL is calculated using Expression (1) below, for example.

$$B\_BL = \frac{B1\_BL}{N} \qquad Expression ( 1 )$$

B_BL is the base layer bit rate after calculation, B1_BL is the stationary mode base layer bit rate, and N is a bit rate reduction parameter that lowers the base layer bit rate in line with terminal movement. For example, if N is set to 10, the base layer bit rate (bit rate) is lowered down to 1/10 in line with terminal movement. N is set to a value that enables guarantee of the minimum bit rate allowing video to be received uninterruptedly even in the case of major bit rate fluctuations due to terminal movement.

The enhancement layer division bit rates may be made the same as in the case of mobile mode, for example.

In step S1400, video coding section 104 performs video coding processing. Specifically, video coding section 104 performs layered coding on an input image from video input section 102, generates coded data composed of a base layer and enhancement layer (see FIG. 3A) and outputs this coded data to channel division section 106. At this time, base layer coding is performed using bit rate B_BL output from bit rate calculation section 112.

Next, in step S1500, channel division section 106 performs channel division processing. Specifically, the enhancement layer is divided into a plurality of channels using coded data output from video coding section 104 and enhancement layer division bit rates B_EL(1) through B_EL(i) output from bit rate calculation section 112, and divided data including the base layer is output to video transmitting section 108 together with a video list (see FIG. 4).

For example, to describe the process taking the example of coded data with the structure shown in FIG. 3A, the base layer is made one channel (BL), and the enhancement layer (EL) is divided into separate channels based on predetermined data amounts.

As an example, if the coded data is divided into four, the enhancement layer (EL) is divided into three—EL_1, EL_2, and EL_3—so that the bit rates of the channels are set bit rates B_BL, B_EL(1), B_EL(2), and B_EL(3) (see FIG. 3B). Of course, the number of divisions is not limited to four.

Then, in step S1600, video transmitting section 108 performs video transmission processing. Specifically, video transmitting section 108 performs multicast transmission of divided data output from channel division section 106 (one base layer and a plurality of divided enhancement layers: see FIG. 3B) to network 180 on the respective corresponding channels, and also performs multicast transmission of the video list showing the bit rate and channel number of each layer (see FIG. 4).

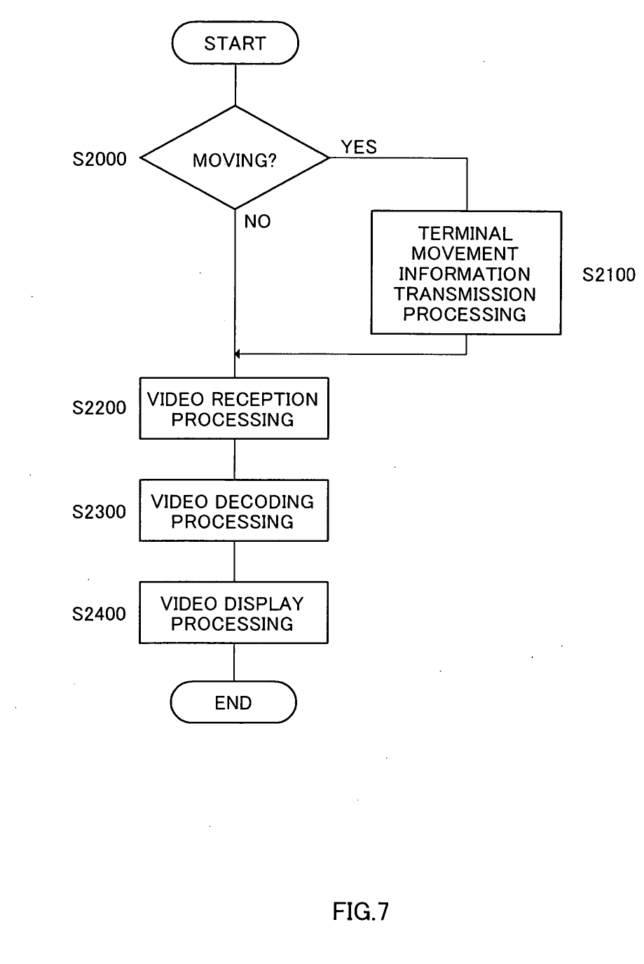

The operation of video receiving apparatus 150 that has the above configuration will now be described using the flowchart shown in FIG. 7. The flowchart shown in FIG. 7 is stored as a control program in a storage device (such as ROM or flash memory, for example) in video receiving apparatus 150 not shown in the figure, and executed by a CPU (also not shown).

First, in step S2000, it is determined whether or not the terminal itself is moving, and more specifically, whether or not the terminal itself is moving or starting to move. This determination is made using, for example, information such as the radio wave status in the terminal, or a handover state spanning radio access points. Another possible method is to have the user explicitly indicate terminal movement. If the result of this determination is that the terminal is moving (S2000: YES), the processing flow proceeds to step S2100, and if the result of this determination is that the terminal is not moving (S2000: NO), the processing flow proceeds directly to step S2200.

In step S2100, terminal information transmitting section 152 performs terminal movement information transmission processing. Specifically, as the terminal is moving, terminal movement information is transmitted to video transmitting apparatus 100, and is also output to video receiving section 154. The processing flow then proceeds to step S2200.

In step S2200, video receiving section 154 performs video reception processing. Specifically, video receiving section 154 receives the video list transmitted from video transmitting apparatus 100, compares the bit rates shown in the video list with the current reception bit rates, and determines a plurality of receivable channel numbers in bottom-up channel number order. As stated above, when terminal movement information is input from terminal information transmitting section 152, at least the base layer channel is received. Then video receiving section 154 receives the video data of the determined channel numbers, outputs the received video data to video decoding section 156, and also measures current reception bit rates from the amount of received video data.

Then, in step S2300, video decoding section 156 performs video decoding processing. Specifically, video decoding section 156decodes video data (coded data) output from video receiving section 154, and outputs the video obtained by decoding to video display section 158.

Next, in step S2400, video display section 158 performs video display processing. Specifically, video output from video decoding section 156 is displayed on a screen.

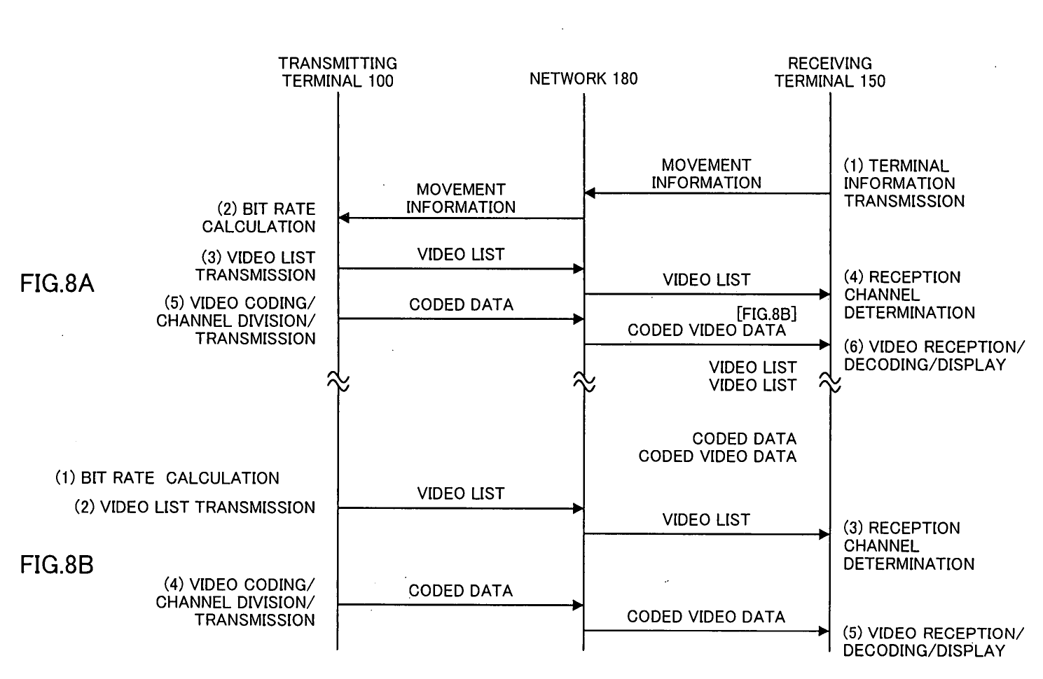

The main signal exchanges in a video transmission system with the above configuration will now be described using the sequence diagrams in FIG. 8A and FIG. 8B. Here, FIG. 8A applies to a moving terminal and FIG. 8B to a stationary terminal.

The case of a moving terminal will first be described using FIG. 8A.

In the case of a moving terminal (including a case where a terminal starts to move), receiving terminal 150 transmits terminal information (more specifically, terminal movement information) to transmitting terminal 100 via network 180 ((1)).

Then, on receiving terminal movement information from receiving terminal 150, transmitting terminal 100 performs bit rate calculation, and more specifically, lowers the base layer bit rate (bit rate) to the limit and sets an ultra-low bit rate ((2)), and transmits a video list to receiving terminal 150 via network 180 ((3)).

Then, on receiving the video list from transmitting terminal 100, receiving terminal 150 performs reception channel determination using the received video list ((4)).

Transmitting terminal 100 then performs video coding and channel division on the input video on a frame-by-frame basis, and transmits coded data after division to receiving terminal 150 via network 180 on separate channels ((5)).

Receiving terminal 150 then receives coded video data from transmitting terminal 100 on the above reception channels, decodes the data, and displays it on a screen ((6)).

Next, the case of a stationary terminal will be described using FIG. 8B.

In the case of a stationary terminal, transmitting terminal 100 does not receive terminal movement information from receiving terminal 150, but performs bit rate calculation, and more specifically, sets the base layer bit rate (bit rate) to a predetermined stationary-mode bit rate ((1)), and then transmits a video list to receiving terminal 150 via network 180 ((2)). The subsequent processing is the same as in the case of a moving terminal shown in FIG. 8A (the corresponding reference numbers in FIG. 8A all being 1 higher than in FIG. 8B), and therefore a description thereof is omitted here.

Thus, according to this embodiment, when receiving terminal 150 is moving, the layered-coded data base layer bit rate is lowered to the limit, and therefore the moving receiving terminal can perform uninterrupted video reception by receiving at least the base layer only.

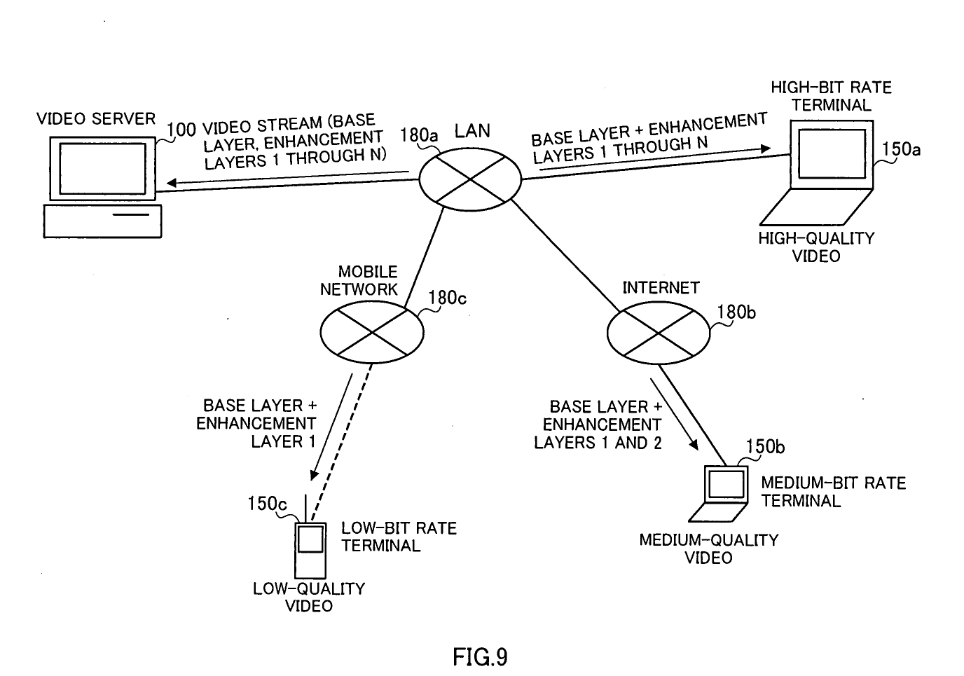

FIG. 9 is a configuration diagram showing an example of a video transmission system using MPEG-4 FGS to which this embodiment is applied.

A video server 100 transmits a video stream composed of a base layer and a plurality of (N) enhancement layers to a video network, and to various terminals 150a, 150bit rate 150c. For example, terminal 150a is a high-bit rate terminal (such as a high-end personal computer or digital television set), terminal 150b is a medium-bit rate terminal (such as a medium-level personal computer), and terminal 150c is a low-bit rate terminal (such as a mobile phone or PDA). High-bit rate terminal 150a is connected to a high-bit rate LAN 180a, medium-bit rate terminal 150b is connected to medium-bit rate Internet 180bit rate low-bit rate terminal 150c is connected to a low-bit rate mobile network 180c.

At this time, terminals 150a, 150bit rate 150c connected respectively to high-bit rate LAN 180a, medium-bit rate Internet 180bit rate low-bit rate mobile network 180c, select streams to be received according to their own reception bit rates, and can receive video of a quality in line with the respective bit rate. For example, high-bit rate terminal 150a receives the base layer and enhancement layers 1 through N, and can obtain high-quality video. Medium-bit rate terminal 150b receives the base layer and two enhancement layers 1 and 2, and can obtain medium-quality video. Low-bit rate terminal 150c receives the base layer and one enhancement layer, enhancement layer 1, and can obtain low-quality video.

Also, at this time, if low-bit rate terminal 150c is moving, video server 100 lowers the base layer bit rate to the limit, and therefore low-bit rate terminal 150c can receive video uninterruptedly by receiving at least the base layer only.

### Embodiment 2

In this embodiment, a video transmission system that transmits a layered-coded video stream in an environment with large bit rate fluctuations, including wireless network, is described whereby it is possible not only to achieve uninterrupted video reception, but also to prevent quality degradation due to a change of base layer bit rate, by lowering the base layer to the limit, and also raising the bit rate of the lowest enhancement layer (that is, the enhancement layer necessary for improving quality of the base layer), when large bit rate fluctuations are expected due to terminal movement and so forth.

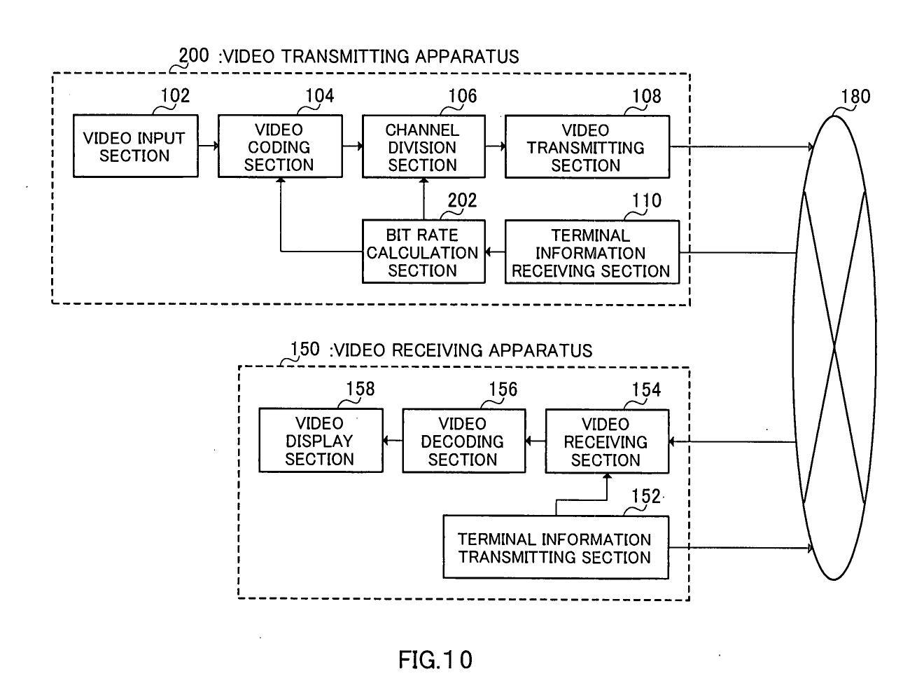

FIG. 10 is a drawing showing the configuration of a video transmission system according to Embodiment 2 of the present invention. A video transmitting apparatus 200 in this video transmission system has a similar basic configuration to that of video transmitting apparatus 100 in the video transmission system shown in FIG. 2, and therefore identical configuration components are assigned the same codes as in FIG. 2, and a description thereof is omitted. Also, video receiving apparatus 150 is exactly the same as shown in FIG. 2, and therefore a description thereof is omitted.

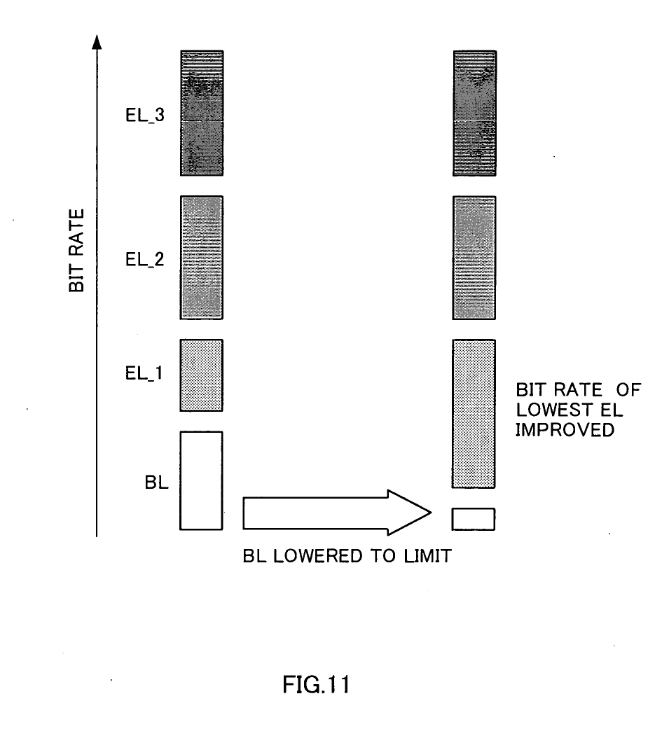

A feature of this embodiment is that, whereas in Embodiment 1 the base layer bit rate was lowered to the limit, only, at the time of terminal movement, here, at the time of terminal movement the base layer bit rate is lowered to the limit and, furthermore, the bit rate of the lowest enhancement layer is raised, providing supplementation of image quality (see FIG. 11). For this purpose, video transmitting apparatus 200 has a bit rate calculation section 202.

In the same way as bit rate calculation section 112 in FIG. 2, bit rate calculation section 202 uses terminal information output from terminal information receiving section 110 to calculate the base layer bit rate and enhancement layer division bit rates, and outputs the former (base layer bit rate) to video coding section 104 and the latter (enhancement layer division bit rates) to channel division section 106. In this embodiment, however, when terminal movement information is input, bit rate calculation section 202 raises the bit rate of the lowest enhancement layer as well as lowering the base layer bit rate. As a result, the effect of lowering the base layer bit rate on other terminals can be suppressed. Details of the processing will be given later herein.

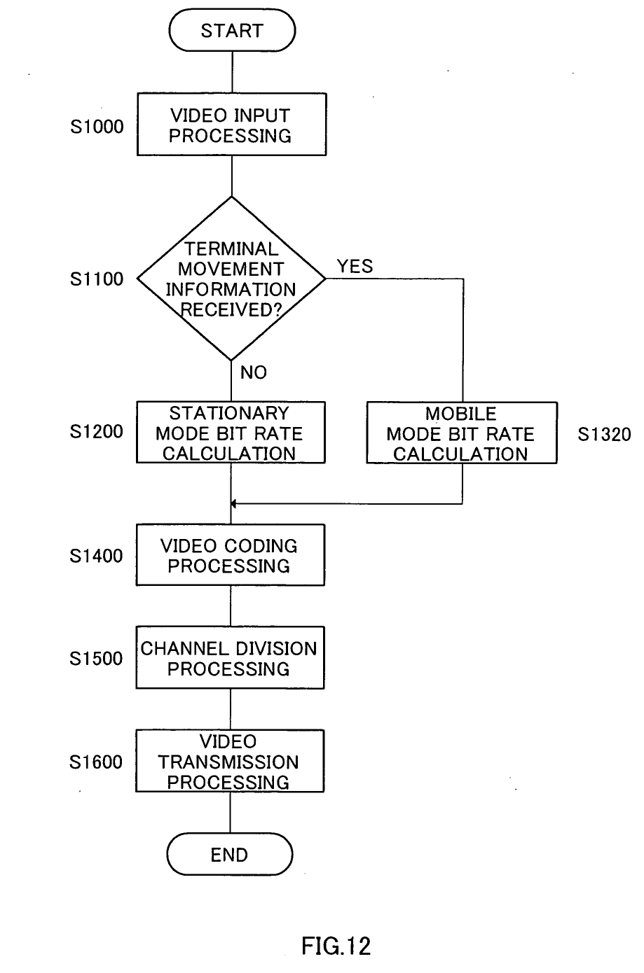

The operation of video transmitting apparatus 200 that has the above configuration will now be described using the flowchart shown in FIG. 12. The flowchart shown in FIG. 12 is stored as a control program in a storage device (such as ROM or flash memory, for example) of video transmitting apparatus 200 not shown in the figure, and executed by a CPU (also not shown).

In this embodiment, as shown in FIG. 12, a step S1320 is inserted in the flowchart shown in FIG. 6, and step S1300 is deleted therefrom.

Step S1000 through step S1200 are the same as the corresponding steps in the flowchart shown in FIG. 6, and therefore a description thereof is omitted.

In step S1320, bit rate calculation section 202 performs mobile mode bit rate calculation processing. Specifically, since this is a case in which terminal movement information from the receiving terminal is received, base layer bit rate B_BL and enhancement layer division bit rates B_EL(1) through B_EL(i) (where i is a preset number of divided layers) are calculated, the base layer bit rate is output to video coding section 104, and the enhancement layer division bit rates are output to channel division section 106. The processing flow then proceeds to step S1400.

Here, the base layer bit rate calculation method is the same as in Embodiment 1, using Expression (1) given above.

On the other hand, enhancement layer division bit rate B_EL(1), is calculated using Expression (2) below, for example.
B_{—}EL(1)=B1_{—}EL(1)+(B1_{—}BL−B_{—}BL) Expression (2)

B_EL(1) is the bit rate of the lowest enhancement layer, B1_EL(1) is the mobile mode bit rate of the lowest enhancement layer, B_BL is the mobile mode base layer bit rate, and B1_BL is the stationary mode base layer bit rate. Bit rates B_EL(2) through B_EL(i) of enhancement layers other than the lowest are the same as for stationary mode.

By improving the bit rate of the lowest enhancement layer in line with a reduction of the base layer bit rate in this way, it is possible to prevent degradation of quality.

Step S1400 through step S1600 are the same as the corresponding steps in the flowchart shown in FIG. 6, and therefore a description thereof is omitted.

Thus, according to this embodiment, when receiving terminal 150 is moving, the layered-coded data base layer bit rate is lowered to the limit, and the bit rate of the lowest enhancement layer is raised, so that not only can the moving receiving terminal perform uninterrupted video reception by receiving at least the base layer only, but also other terminals can prevent degradation of received video quality due to lowering of the base layer bit rate.

### Embodiment 3

In this embodiment, a video transmission system that transmits a layered-coded video stream in an environment with large bit rate fluctuations, including wireless network, is described whereby it is possible not only to achieve uninterrupted video reception, but also to improve received video quality to the greatest possible degree at the time of bit rate fluctuations, by lowering the base layer to the limit, and also finely dividing the bit rate of the lowest enhancement layer (that is, the enhancement layer necessary for improving quality of the base layer), when large bit rate fluctuations are expected due to terminal movement and so forth.

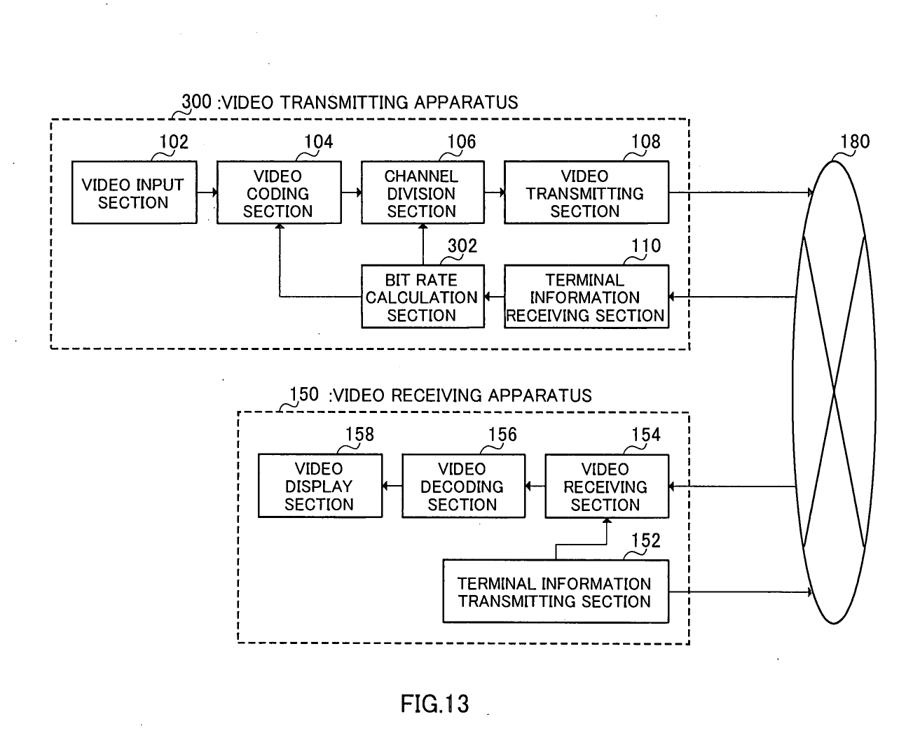

FIG. 13 is a drawing showing the configuration of a video transmission system according to Embodiment 3 of the present invention. A video transmitting apparatus 300 in this video transmission system has a similar basic configuration to that of video transmitting apparatus 100 in the video transmission system shown in FIG. 2, and therefore identical configuration components are assigned the same codes as in FIG. 2, and a description thereof is omitted. Also, video receiving apparatus 150 is exactly the same as shown in FIG. 2, and therefore a description thereof is omitted.

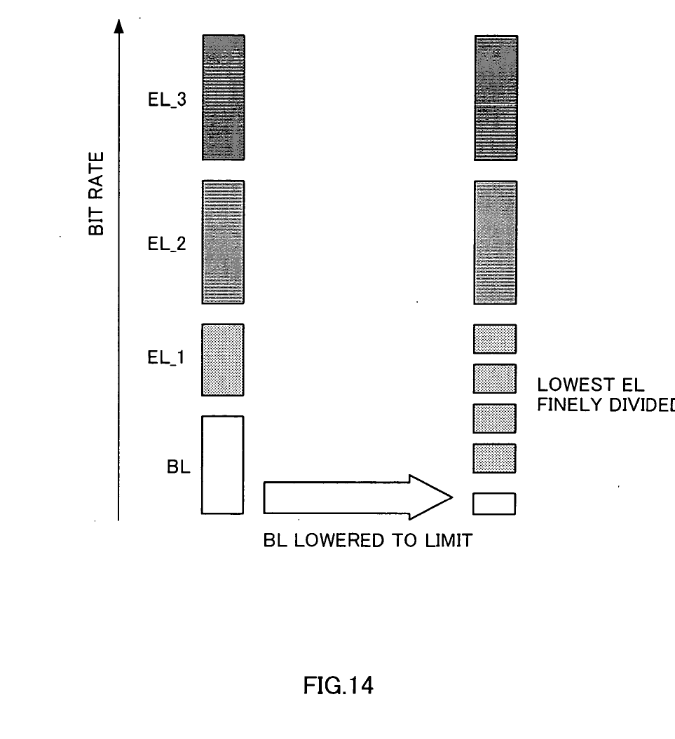

A feature of this embodiment is that, whereas in Embodiment 1 the base layer bit rate was lowered to the limit, only, at the time of terminal movement, here, at the time of terminal movement the base layer bit rate is lowered to the limit and, furthermore, the bit rate of the lowest enhancement layer is raised, and is then finely divided, improving its fitness as a bit rate at the time of bit rate fluctuations (see FIG. 14). For this purpose, video transmitting apparatus 300 has a bit rate calculation section 302.

In the same way as bit rate calculation section 112 in FIG. 2, bit rate calculation section 302 uses terminal information output from terminal information receiving section 110 to calculate the base layer bit rate and enhancement layer division bit rates, and outputs the former (base layer bit rate) to video coding section 104 and the latter (enhancement layer division bit rates) to channel division section 106. In this embodiment, however, when terminal movement information is input, bit rate calculation section 302 raises and finely divides the bit rate of the lowest enhancement layer as well as lowering the base layer bit rate. As a result, the effect of lowering the base layer bit rate on other terminals can be suppressed, and moreover, fitness as a bit rate at the time of bit rate fluctuations can be improved. Details of the processing will be given later herein.

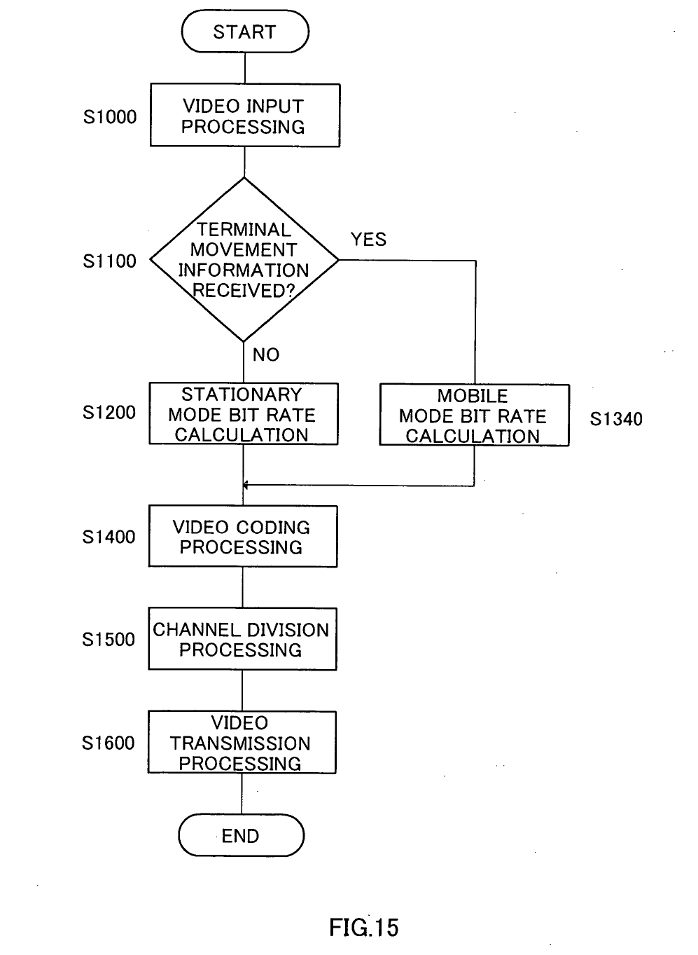

The operation of video transmitting apparatus 300 that has the above configuration will now be described using the flowchart shown in FIG. 15. The flowchart shown in FIG. 15 is stored as a control program in a storage device (such as ROM or flash memory, for example) of video transmitting apparatus 300 not shown in the figure, and executed by a CPU (also not shown).

In this embodiment, as shown in FIG. 15, a step S1340 is inserted in the flowchart shown in FIG. 6, and step S1300 is deleted therefrom.

Step S1000 through step S1200 are the same as the corresponding steps in the flowchart shown in FIG. 6, and therefore a description thereof is omitted.

In step S1340, bit rate calculation section 302 performs mobile mode bit rate calculation processing. Specifically, since this is a case in which terminal movement information from the receiving terminal is received, base layer bit rate B_BL and enhancement layer division bit rates B_EL(1) through B_EL(i) (where i is a preset number of divided layers) are calculated, the base layer bit rate is output to video coding section 104, and the enhancement layer division bit rates are output to channel division section 106. The processing flow then proceeds to step S1400.

Here, the base layer bit rate is calculated using Expression (1) given above in the same way as in Embodiment 1.

On the other hand, enhancement layer division bit rate B_EL(j) is calculated using Expressions (3) below, for example.

$$\begin{matrix}B\_EL ( j ) = \frac{B1\_EL ( 1 ) + ( B1\_BL - B\_BL )}{M} ( j \leq M ) \\ \begin{matrix}B\_EL ( j ) = B1\_EL ( j - M ) & ( j > M )\end{matrix}\end{matrix} \qquad Expressions ( 3 )$$

B_EL(j) is the bit rate of the level j enhancement layer when the lowest level is level 1, B1_EL(1) is the mobile mode bit rate of the lowest enhancement layer, B_BL is the mobile mode base layer bit rate, B1_BL is the stationary mode base layer bit rate, and M is the number of divisions of the lowest enhancement layer.

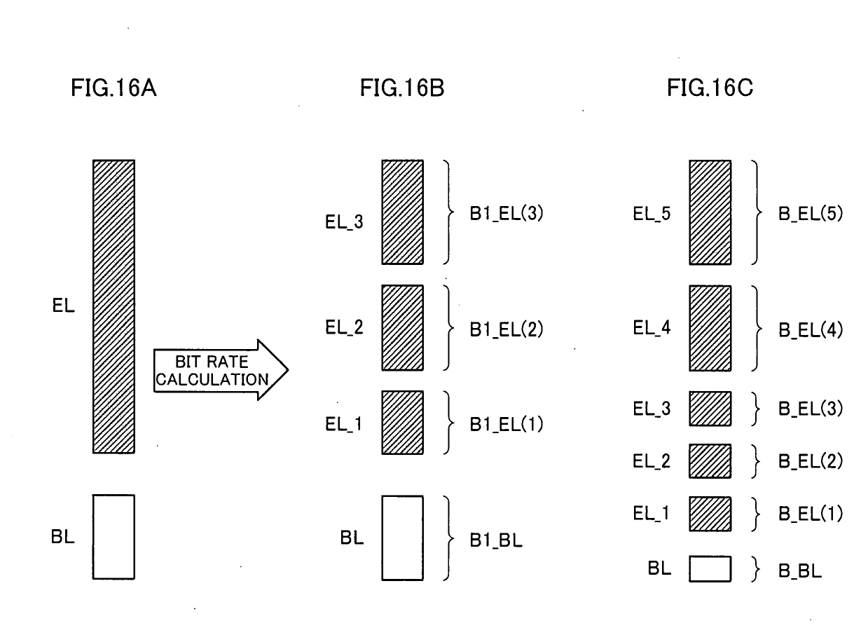

An example of the result of bit rate division in mobile mode when M=3 is shown in FIG. 16C. FIG. 16A shows the structure of the coded data, and FIG. 16B shows an example of the result of channel division in stationary mode. FIG. 16A and FIG. 16B correspond to FIG. 3A and FIG. 3B, respectively.

By improving the bit rate of the lowest enhancement layer, and then dividing it finely, in line with a reduction of the base layer bit rate in this way, it is possible to adapt received video quality in fine units in an environment in which there are large bit rate fluctuations by having each terminal select receivable channels from a video list.

Step S1400 through step S1600 are the same as the corresponding steps in the flowchart shown in FIG. 6, and therefore a description thereof is omitted.

Thus, according to this embodiment, when receiving terminal 150 is moving, the layered-coded data base layer bit rate is lowered to the limit, and the bit rate of the lowest enhancement layer is raised and divided finely, increasing the number of channels, so that the moving receiving terminal can not only perform uninterrupted video reception, but also perform video reception at a quality finely adapted to the transmission bit rate, by selectively receiving receivable divided enhancement layers in addition to the base layer.

### Embodiment 4

In this embodiment, a video transmission system that transmits a layered-coded video stream in an environment with large bit rate fluctuations, including wireless network, is described whereby it is possible to achieve an improvement in video reception efficiency by calculating the enhancement layer configuration in accordance with the receiving terminal layer reception status.

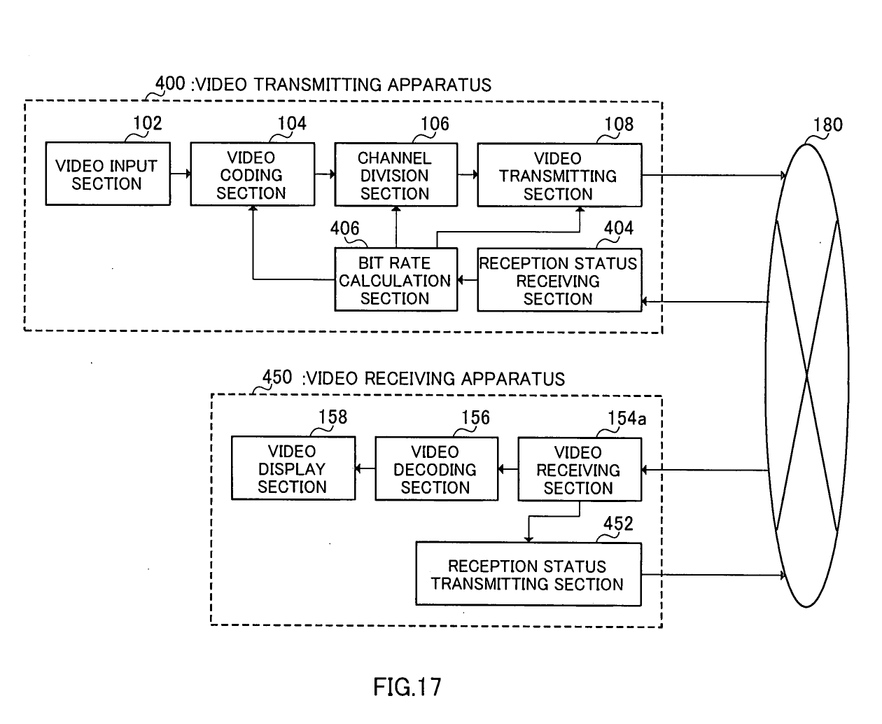

FIG. 17 is a drawing showing the configuration of a video transmission system according to Embodiment 4 of the present invention. A video transmitting apparatus 400 and video receiving apparatus 450 in this video transmission system have similar basic configurations to those of video transmitting apparatus 100 and video receiving apparatus 150 in the video transmission system shown in FIG. 2, and therefore identical configuration components are assigned the same codes as in FIG. 2, and a description thereof is omitted.

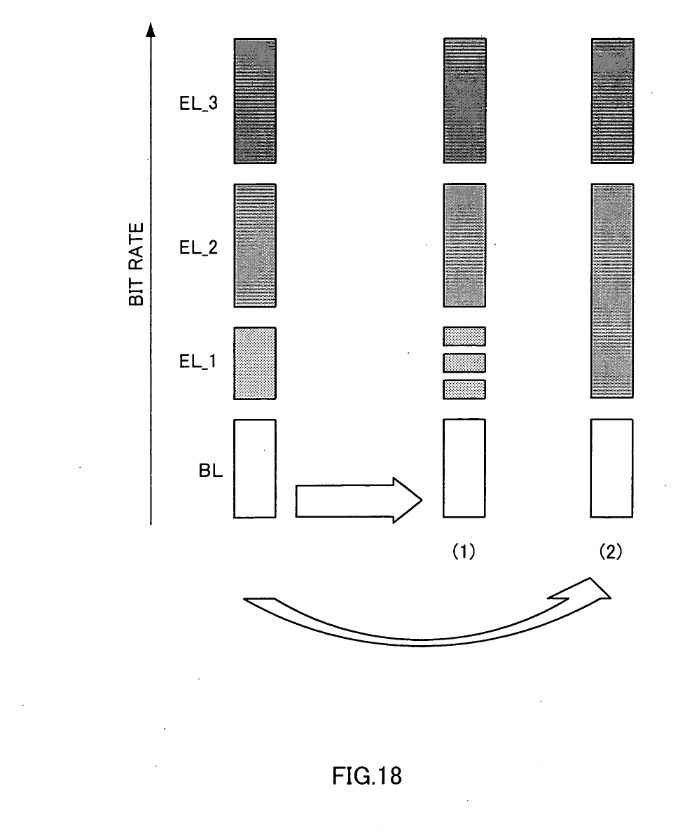

A feature of this embodiment is that the bit rate of each enhancement layer is determined using reception layer information (specifically, information on layers being received by a receiving terminal). For example, an enhancement layer for which the number of receiving terminals is small is further divided (see (1) in FIG. 18), and a plurality of enhancement layers being received in common among all receiving terminals are combined into one layer (see (2) in FIG. 18). For this purpose, video transmitting apparatus 400 has a video transmitting section 402, reception status receiving section 404, and bit rate calculation section 406, and video receiving apparatus 450 has a reception status transmitting section 452.

In the same way as video transmitting section 108 in FIG. 2, video transmitting section 402 transmits divided data and a video list output from channel division section 106 to network 180 on separate channels. Furthermore, in this embodiment, a video list output from bit rate calculation section 406 is also transmitted to network 180. The video list output from channel division section 106 and the video list output from bit rate calculation section 406 are of the same kind (see FIG. 4) Reception status receiving section 404 receives reception statuses transmitted from a plurality of receiving terminals (video receiving apparatuses 450), generates reception layer information summarizing the reception statuses of the receiving terminals, and outputs this reception layer information to bit rate calculation section 406. Here, a reception status is information showing the names of layers currently being received by each receiving terminal, and reception layer information is information showing the total number of receiving terminals for each layer.

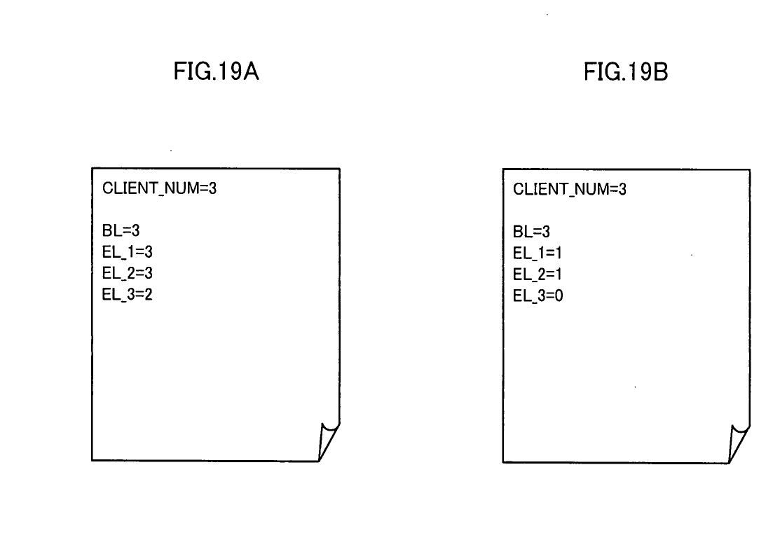

Examples of reception layer information are shown in FIG. 19A and FIG. 19B. Here, CLIENT_NUM shows the total number of receiving terminals, and BL=x and EL_I=y indicate respectively that the number of terminals receiving the base layer is x and that the number of terminals receiving enhancement layer EL_I (where I is the enhancement layer number) is y.

Bit rate calculation section 406 calculates enhancement layer division bit rates using reception layer information output from reception status receiving section 404, and outputs the calculated enhancement layer division bit rates to channel division section 106. Bit rate calculation section 406 also outputs a preset base layer bit rate to video coding section 104.

Reception status transmitting section 452 transmits information on layers currently being used by the relevant video receiving apparatus 450 to the transmitting apparatus (video transmitting apparatus 400) as a reception status. At this time, information on layers currently being received is supplied from video receiving section 154a.

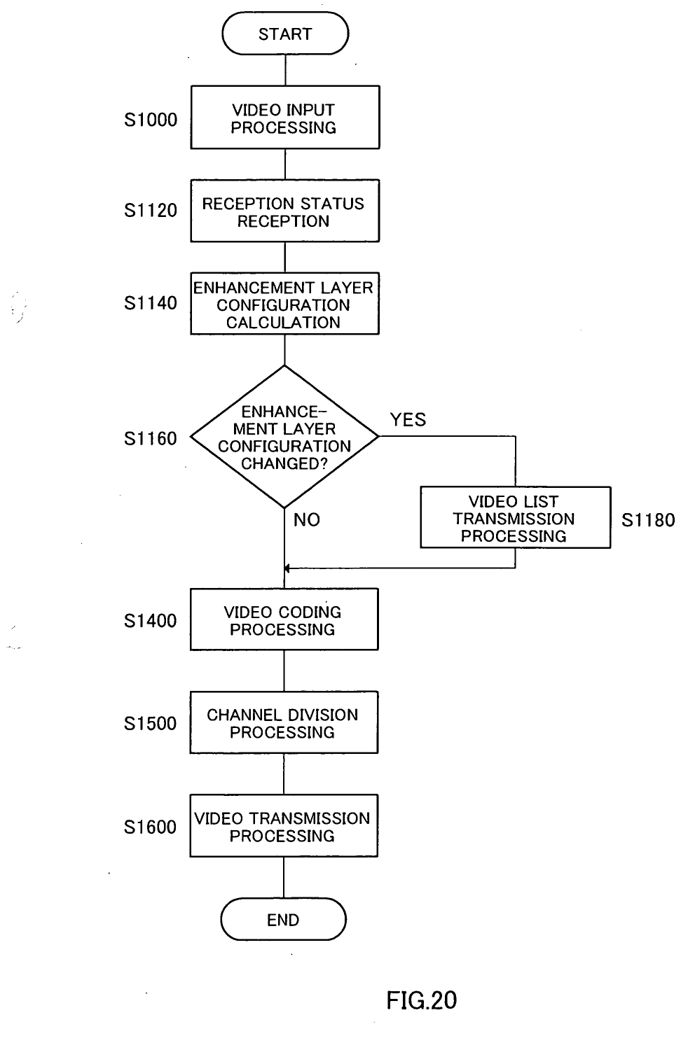

The operation of video transmitting apparatus 400 that has the above configuration will now be described using the flowchart shown in FIG. 20. The flowchart shown in FIG. 20 is stored as a control program in a storage device (such as ROM or flash memory, for example) of video transmitting apparatus 400 not shown in the figure, and executed by a CPU (also not shown).

In this embodiment, as shown in FIG. 20, a step S1120, step S1140, step S1160, and step S1180 are inserted in the flowchart shown in FIG. 6, and step S1100, step S1200, and step S1300 are deleted therefrom.

Step S1000 is the same as the corresponding step in the flowchart shown in FIG. 6, and therefore a description thereof is omitted.

In step S1120, reception status receiving section 404 performs reception status reception processing. Specifically, reception status receiving section 404 receives reception statuses transmitted from a plurality of receiving terminals (video receiving apparatuses 450), generates reception layer information (see FIG. 19A and FIG. 19B), and outputs this information to bit rate calculation section 406.

Then, in step S1140, bit rate calculation section 406 performs enhancement layer configuration calculation processing. Specifically, bit rate calculation section 406 outputs a preset base layer bit rate to video coding section 104, and also calculates the enhancement layer configuration—that is, division layers—using reception layer information output from reception status receiving section 404, and outputs the obtained enhancement layer division bit rates to channel division section 106.

Here, enhancement layer division is performed using Expressions (4) and Expressions (5) below, for example.

$$\begin{matrix}B\_EL {( 1 )}^{′} = B\_EL ( 1 ) + {\sum }_{K = 2}^{m} B\_EL ( k ) & Expressions ( 4 ) \\ \begin{matrix}B\_EL {( i )}^{′} = B\_EL ( i + m - 1 ) & ( i \geq 2 )\end{matrix} & \\ \begin{matrix}B\_EL {( i )}^{′} = \frac{B\_EL ( 1 )}{M} & ( i \leq M )\end{matrix} & Expressions ( 5 ) \\ \begin{matrix}B\_EL {( i )}^{′} = B\_EL ( i - M + 1 ) & ( i > M )\end{matrix} & \end{matrix}$$

That is to say, when the total number of enhancement layers being received by all receiving terminals is 1 or more, Expressions (4) are used. In Expressions (4), B_EL(i)′ is the bit rate of enhancement layer i after bit rate calculation, B_EL(i) is the previous enhancement layer i bit rate, and m is the total number of enhancement layers being received by all receiving terminals. For example, in the example in FIG. 19A, since the total number of terminals is 3 and the number of receiving terminals is 3 for both EL_1 and EL_2, m=2.

Thus, when Expressions (4) are used, consolidating the enhancement layers received by all terminals into one enables overhead such as header information to be reduced and transmission efficiency to be improved (see (2) in FIG. 18).

If the total number of enhancement layers being received by all terminals is 0 and the condition in Expression (6) below is satisfied, Expressions (5) are used.
if((CLIENT_NUM/K)>N(EL_{—}1)) Expression (6)

That is to say, when there are few receiving terminals, the lowest enhancement layer is divided. In Expressions (5), M is a bit rate division parameter, a parameter for dividing the enhancement layer EL_1 bit rate equally. In Expression (6), K is a terminal division parameter, CLIENT_NUM is the total number of receiving terminals, and N(EL_1) is the number of terminals receiving enhancement layer EL_1.

Referring to FIG. 19B, assuming that K=2 and M=3, for example, if half of the total number of terminals are not receiving EL_1, enhancement layer EL_1 can be divided into three using Expressions (5), making it easier for more terminals to receive enhancement layers.

If the total number of enhancement layers being received by all terminals is 0 and the condition in Expression (6) is not satisfied, the same bit rates are used as previously.

Then, in step S1160, bit rate calculation section 406 determines whether or not the layer configuration has been changed as a result of processing in step S1140. This determination is made according to whether or not the enhancement layer division bit rates are different from the bit rates calculated previously. If the result of this determination is that the enhancement layer configuration has changed (S1160: YES), a video list (see FIG. 4) is generated and output to video transmitting section 402, and the processing flow proceeds to step S1180. If, on the other hand, the enhancement layer configuration has not changed (S1160: NO), the processing flow proceeds directly to step S1400.

In step S1180, video transmitting section 402 performs video list transmission processing. Specifically, the video list output from bit rate calculation section 406 is transmitted to network 180. The processing flow then proceeds to step S1400.

Step S1400 through step S1600 are the same as the corresponding steps in the flowchart shown in FIG. 6, and therefore a description thereof is omitted.

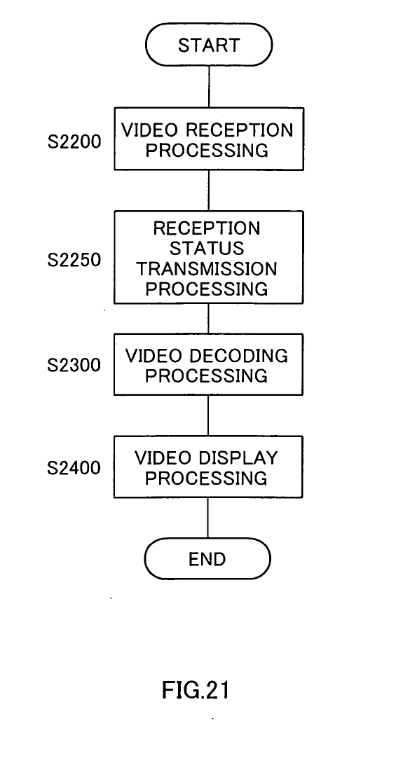

The operation of video receiving apparatus 450 that has the above configuration will now be described using the flowchart shown in FIG. 21. The flowchart shown in FIG. 21 is stored as a control program in a storage device (such as ROM or flash memory, for example) in video receiving apparatus 450 not shown in the figure, and executed by a CPU (also not shown).

In this embodiment, as shown in FIG. 21, a step S2250 is inserted in the flowchart shown in FIG. 7, and step S2000 and step S2100 are deleted therefrom.

Step S2000 is the same as the corresponding step in the flowchart shown in FIG. 7, and therefore a description thereof is omitted. In this embodiment, video receiving section 154a outputs information on layers currently being received to reception status transmitting section 452.

In step S2250, reception status transmitting section 452 performs reception status transmission processing. Specifically, reception status transmitting section 452 transmits information indicating the names of layers currently being received by the relevant video receiving apparatus 450 to the transmitting terminal (video transmitting apparatus 400) as a reception status.

In this embodiment, reception status transmission is performed each time video reception processing is carried out, but this is not a limitation, and it is also possible to transmit at a fixed interval to avoid transmission path congestion.

Step S2300 and step S2400 are the same as the corresponding steps in the flowchart shown in FIG. 7, and therefore a description thereof is omitted.

Thus, according to this embodiment, transmission efficiency can be improved by making a plurality of enhancement layers being received in common a single enhancement layer, or higher-quality video can be received by many terminals by further dividing the lowest enhancement layer when the number of receiving terminals is small.

As described above, according to the present invention uninterrupted video transmission can be achieved, even when there are large bit rate fluctuations due to receiving terminal movement and so forth, in a network such as a wireless network in which transmission bit rate fluctuations occur.

This application is based on Japanese Patent Application No. 2003-053779 filed on Feb. 28, 2003, the entire content of which is expressly incorporated by reference herein.

### INDUSTRIAL APPLICABILITY

The present invention has an effect of achieving uninterrupted video transmission, even when there are large bit rate fluctuations due to receiving terminal movement and so forth, in a network such as a wireless network in which transmission bit rate fluctuations occur, and is applicable to a video transmission system that transmits video via a network and a video receiving apparatus and video transmitting apparatus used in that system.

1. A video receiving apparatus that receives layered-coded data, said video receiving apparatus comprising:
a transmitting section that transmits specific information indicating that said video receiving apparatus is moving or that said video receiving apparatus starts to move; and
a receiving section that receives the divided layered-coded data whose base layer bit rate has been lowered based on the received specific information.

2. (canceled)

3. The video receiving apparatus according to claim 1, wherein said receiving section receives a lowermost enhancement layer whose bit rate has been raised when a bit rate of the base layer whose bit rate has been lowered is received.

4. The video receiving apparatus according to claim 1, wherein said receiving section receives a lowermost enhancement layer whose bit rate has been divided when the base layer whose bit rate has been lowered is received.

5. The video receiving apparatus according to claim 1, wherein:
said transmitting section transmits information indicating a layer reception status of said video receiving apparatus; and
said receiving section receives the divided layered-coded data whose enhancement layer bit rate has been determined in accordance with the layer reception status of said video receiving apparatus.

6. The video receiving apparatus according to claim 5, wherein said receiving section receives a lowermost enhancement layer whose bit rate has been divided when a number of receiving terminals indicated by the layer reception status of said video receiving apparatus is less than or equal to a predetermined value.

7. The video receiving apparatus according to claim 5, wherein said receiving section, when there exists a plurality of enhancement layers received in common in an enhancement layer reception status indicated by the layer reception status of said video receiving apparatus, receives the enhancement layer wherein those common enhancement layers are consolidated into one layer.

8. A video transmitting apparatus comprising:
a receiving section that receives specific information indicating that a video receiving apparatus is moving or that said video receiving apparatus starts to move;
a control section that lowers a base layer bit rate of divided layer-coded data using the received specific information; and
a transmitting section that transmits the layered-coded data whose bit rate has been lowered.

9. (canceled)

10. The video transmitting apparatus according to claim 8, wherein said control section raises a bit rate of a lowermost enhancement layer when lowering the base layer bit rate.

11. The video transmitting apparatus according to claim 8, wherein said control section divides a bit rate of a lowermost enhancement layer when lowering the base layer bit rate.

12. The video transmitting apparatus according to claim 8, wherein:
said receiving section receives information indicating a layer reception status of said video receiving apparatus; and
said control section determines a bit rate of an enhancement layer among the divided layered-coded data using the information indicating the layer reception status of said video receiving apparatus.

13. The video transmitting apparatus according to claim 12, wherein said control section uses the information indicating the layer reception status of said video receiving apparatus and further divides a bit rate of a lowermost enhancement layer when a number of receiving terminals is less than or equal to a predetermined value.

14. The video transmitting apparatus according to claim 12, wherein said control section uses the information indicating the reception status of said video receiving apparatus and when there exist enhancement layers received in common consolidates those common enhancement layers into one layer.

15. A video transmission system whereby divided layered-coded data is transmitted from a video transmitting apparatus to a video receiving apparatus via a network, wherein:
said video transmitting apparatus comprises:
a receiving section that receives specific information indicating that said video receiving apparatus is moving or said video apparatus starts to move; and
a control section that lowers a base layer bit rate of the divided layered-coded data using the received specific information;
and said video receiving apparatus comprises a transmitting section that transmits said specific information.
